(19) United States
(12) Patent Application Publication
(10) Pub. No.: US 2015/0360559 A1
(43) Pub. Date: Dec. 17, 2015

(54) METHOD FOR THE OPERATION OF A RADIATOR GRILL ARRANGEMENT OF A VEHICLE

(71) Applicant: DAIMLER AG, Stuttgart (DE)

(72) Inventor: Holger JAKOBS, Dettenhausen (DE)

(73) Assignee: Daimler AG, Stuttgart (DE)

(21) Appl. No.: 14/766,657

(22) PCT Filed: Jan. 18, 2014
(86) PCT No.: PCT/EP2014/000132

§ 371 Date: Aug. 7, 2015

(30) Foreign Application Priority Data
Feb. 8, 2013 (DE) 102013002362.9

(51) Int. Cl. B60K 11/08; F01P 11/10

(52) U.S. Cl. CPC B60K 11/085; F01P 11/10

(57) ABSTRACT

A method for the operation of a radiator grill arrangement of a vehicle is disclosed. The radiator grill arrangement includes at least one primary air inlet and a number of closure flaps which are moved between a closing position and an opening position by at least one actuator. A reference motion sequence of the at least one actuator is carried out depending on a predetermined temperature.

### BACKGROUND AND SUMMARY OF THE INVENTION

The invention relates to a method for the operation of a radiator grill arrangement of a vehicle, which comprises at least one primary air inlet and a number of closure flaps which are moved between a closing position and an opening position by means of at least one actuator.

A radiator grill arrangement for a vehicle and a method for the operation of such a radiator grill arrangement are known from DE 10 2012 012 677 A1. The radiator grill arrangement comprises at least one support frame surrounding a primary air inlet, a number of closure flaps, which are mounted for rotation around a flap axis of rotation between an opening position and a closing position, wherein flap levers are molded or formed on the closure flaps, the levers being in an operative connection with a sliding bolt, and comprises an actuator, by means of which the closure flaps are positioned.

The object the invention is to specify a method for the operation of a radiator grill arrangement of a vehicle that is an improvement over the prior art.

A method for the operation of a radiator grill arrangement of a vehicle, which comprises at least one primary air inlet and a number of closure flaps, provides that the closure flaps are moved between a closing position and an opening position by means of at least one actuator. According to the invention, a reference motion sequence of the at least one actuator is carried out depending on a predetermined temperature.

What is to be understood by the reference motion sequence of the actuator is that the closure flaps are moved from the closing position into the opening position and back for referencing the actuator.

In order to prevent parts of the radiator grill arrangement from being damaged by the reference motion sequence of the at least one actuator, in particular due to influences caused by the weather, such as snow and ice, the reference motion sequence is carried out depending on the predetermined temperature.

In a particularly advantageous manner, the reference motion sequence is carried out at a predetermined temperature, in particular an ambient temperature, above the freezing point, such that the risk of damaging parts of the radiator grill arrangement by snow and/or ice is at least reduced.

The operational safety of the radiator grill arrangement is increased by the method, wherein the risk of mechanical damage by opening and closing the closure flaps, which is caused with the aid of an actuator-dependent release of the reference motion sequence, is minimized.

The referencing of the actuator is limited to opening the closure flaps which are established by technical requirements of the vehicle, in the particular the cooling system.

Exemplary embodiments of the invention are illustrated in greater detail below with the aid of a drawing.

### BRIEF DESCRIPTION OF THE DRAWING

FIG. 1 illustrates in a schematic view, a vehicle having a radiator grill arrangement.

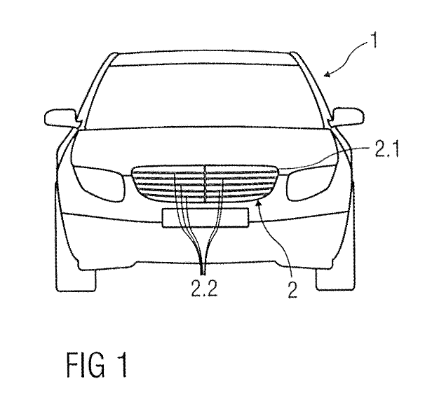

### DETAILED DESCRIPTION OF THE DRAWING

In the single FIGURE, a vehicle 1 having a radiator grill arrangement 2 arranged in the front region is shown. The radiator grill arrangement 2 consists of at least one support frame 2.1 surrounding a primary air inlet, closure flaps 2.2 which have a closing position in the present exemplary embodiment, and an actuating drive (not shown) as an actuator, which is coupled to the closure flaps 2.2 and by means of which the closure flaps 2.2 are able to be positioned.

Such a radiator grill arrangement 2 serves to open and close the primary inlet opening depending on operating states of the vehicle 1. The primary inlet opening is closed, in particular, when there is low heat load or when the combustion engine is switched off, in order to prevent unnecessary cooling by airflow and/or an undesired heat discharge through the primary inlet opening. Moreover, closing the primary inlet opening can lead to a considerable improvement in the drag coefficient, the so-called cw value of the vehicle 1, when there is comparably high driving speed.

The radiator grill arrangement 2 has two flap rows, which each have the same number of closure flaps 2.2 and are arranged one alongside the other.

The closure flaps 2.2 are mounted pivotably within their flap row between the closing position and an opening position that is not depicted in greater detail, wherein the closure flaps 2.2 are mounted for horizontal pivoting.

The actuator as an actuating drive is a self-referencing actuator, wherein the closure flaps 2.2 are positioned from the closing position into the opening position and back again during a reference motion sequence of the actuator.

If components of the radiator grill arrangement 2 are, for example, iced over and/or there is snow thereon, the danger exists that one or more components will be mechanically damaged when the reference motion sequence is carried out.

In order to be able to at least reduce the danger of mechanical damage due to a reference motion sequence of the actuator that is carried out when there is ice and/or snow, provision is made to carry out the reference motion sequence depending on a predetermined temperature. The predetermined temperature is, for example, 0° C.

For this, provision is particularly made for the reference motion sequence to be carried out as a result of a technical necessity of the vehicle 1, in particular its cooling system. This means that the reference motion sequence is carried out if there is a first requirement initiated by the cooling system for opening the closure flaps 2.2. The opening of the closure flaps 2.2 serves, in this way, to cool engine components of the vehicle 1.

A potentially existing emergency opening function of the actuator, in which the closure flaps 2.2 are located in the opening position, remains as a possible alternative when the vehicle 1 is parked in its operating position and is locked in a suitable manner.

In a further potential alternative, the actuator is not activated when the prevailing ambient temperature is at the freezing point, such that the closure flaps 2.2 remain in the closing position.

The risk of mechanical damage to components of the radiator grill arrangement, in particular the drive mechanism, due to ice and/or snow, is reduced by means of the temperature-dependent implementation of the reference motion sequence.

1.-4. (canceled)

5. A method for operation of a radiator grill arrangement of a vehicle, wherein the radiator grill arrangement includes a primary air inlet and a plurality of closure flaps which are moveable between a closing position and an opening position by an actuator, comprising the step of:
carrying out a reference motion sequence of the actuator depending on a predetermined temperature.

6. The method according to claim 5, wherein the reference motion sequence of the actuator is carried out depending on a temperature of a coolant circulating in a cooling system of the vehicle.

7. The method according to claim 6, wherein the reference motion sequence of the actuator is carried out in the opening position of the closure flaps as required by the cooling system depending on the temperature.

8. The method according to claim 5, wherein the reference motion sequence of the actuator is carried out depending on an ambient temperature.

9. The method according to claim 5, wherein the predetermined temperature is a temperature at which water freezes.

10. The method according to claim 9, wherein the carrying out is not performed when the predetermined temperature is the temperature at which water freezes.

11. The method according to claim 9, wherein the carrying out is performed when the predetermined temperature is above the temperature at which water freezes.
